(19) United States
(12) Patent Application Publication
(10) Pub. No.: US 2007/0109361 A1
(43) Pub. Date: May 17, 2007

(54) FLUID INJECTION APPARATUS

(75) Inventors: Wei Lin Chen, Taipei (TW); Der Rong Shyn, Hsinchu County (TW); Fan Chung Tseng, Hsinchu City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/559,160

(22) Filed: Nov. 13, 2006

(30) Foreign Application Priority Data
Nov. 14, 2005 (TW) TW94139894

(51) Int. Cl. B41J 2/05

(52) U.S. Cl. 347/63; 425/375

(57) ABSTRACT

A fluid injection apparatus is disclosed. A manifold connects a plurality of fluid chambers to supply fluids thereto. A plurality of nozzles are connected to the fluid chambers respectively to eject the fluids, wherein at least two of the nozzles are not disposed along a column or a row, and distances between the nozzles and the manifold are substantially the same.

### BACKGROUND OF THE INVENTION

1. Field of the Invention

The invention relates to a fluid injection apparatus, and in particular relates to a micro fluid injection apparatus.

2. Description of the Related Art

Micro fluid injection apparatuses have been widely used in digital apparatuses, such as inkjet printers or others. With the development of micro system engineering, micro fluid injection apparatuses are further used in other applications, such as fuel injection systems, cell sorting, drug delivery systems, print lithography or micro jet propulsion systems.

FIG. 1 shows a conventional fluid injection apparatus 100, in which distances between fluid injection units 112 and a corresponding manifold 110 vary, thus affecting performance thereof.

### BRIEF SUMMARY OF INVENTION

A detailed description is given in the following embodiments with reference to the accompanying drawings. These and other problems are generally solved or circumvented, and technical advantages are generally achieved, by preferred illustrative embodiments of the present invention, which provide a fluid injection apparatus.

The invention provides a fluid injection apparatus. A manifold connects a plurality of fluid chambers to supply fluids thereto. A plurality of nozzles are connected to the fluid chambers respectively to eject the fluids, wherein at least two of the nozzles are not disposed along a column or a row, and distances between the nozzles and the manifold are substantially the same.

The invention provides a fluid injection apparatus. A manifold comprises a plurality of chamber inlets, connecting a plurality of fluid chambers through the chamber inlets to supply fluids to the fluid chambers respectively. A plurality of nozzles is connected to corresponding fluid chambers to eject the fluids, wherein at least two of the nozzles are not disposed along a column or a row, and horizontal distances between the nozzle and the manifold are substantially the same.

The invention provides a fluid injection apparatus. A plurality of fluid chambers are disposed on or in the substrate, wherein each fluid chamber comprises a nozzle plate covering the fluid chamber, each nozzle plate comprises a nozzle, and at least two of the nozzles are not disposed in a column or in a row. A manifold is disposed in the substrate, connecting the fluid chambers, wherein horizontal distances between the nozzles and the manifold are substantially the same.

### BRIEF DESCRIPTION OF THE DRAWINGS

The present invention can be more fully understood by reading the subsequent detailed description and examples with references made to the accompanying drawings, wherein:

FIG. 1 shows a conventional fluid injection apparatus.

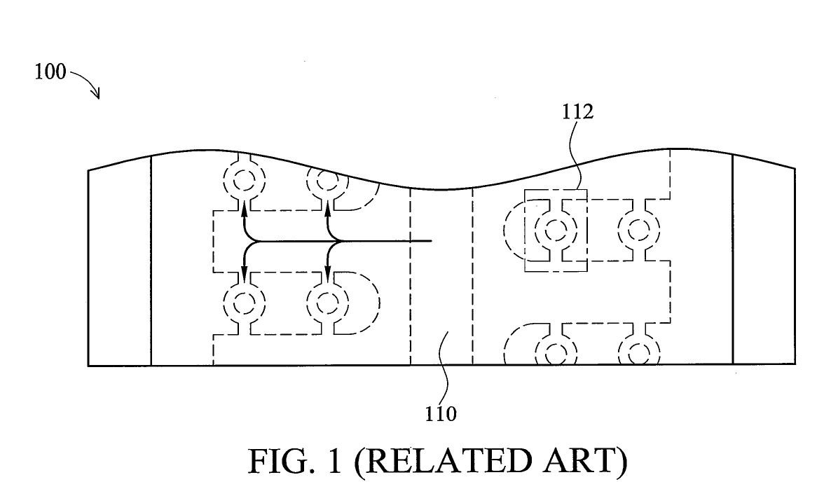

FIG. 2 is shows a fluid injection apparatus known by the inventor.

FIG. 3A˜FIG. 3C show intermediate plan views of a fluid injection apparatus of an embodiment of the invention.

FIG. 3D shows a plan view of a fluid injection apparatus of an embodiment of the invention.

FIG. 3E shows a cross section along a I-I′ line of FIG. 3D.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims. Embodiments of the invention, which provides a fluid injection apparatus, will be described in greater detail by referring to the drawings that accompany the invention. It is noted that in the accompanying drawings, like and/or corresponding elements are referred to by like reference numerals. The invention is not limited to any particular fluid driving device or driving method, which is not particularly mentioned in the specification. The invention can further comprise any fluid driving device, such as thermal driven bubble or piezoelectric actuator, or driving method.

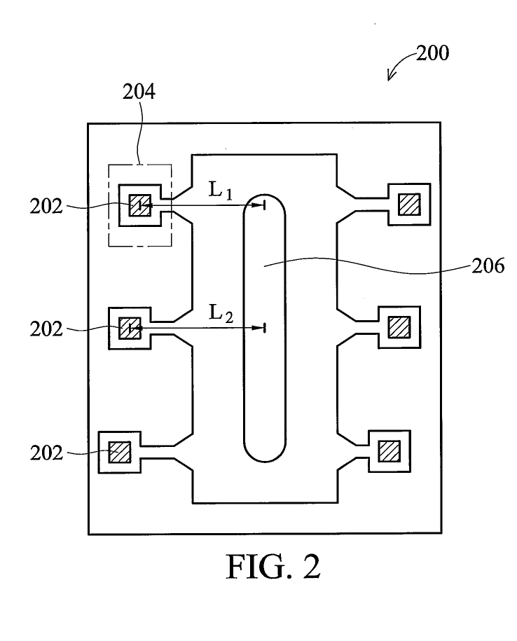

FIG. 2 shows a plan view of a fluid injection apparatus. This is not prior art for the purpose of determining the patentability of the present invention. This merely shows a problem found by the inventors. Referring to FIG. 2, a fluid injection apparatus 200 comprises a plurality of nozzles 202. The nozzles are not arranged in a row or in a column to inject ink to a right location, not affected by scanning sequence of the nozzles 202. A distance L1 between a fluid injection unit 204 and the manifold 206, however, is different with the distance L2 between another fluid injection unit 204 and the manifold 206. Thus, performance of the fluid injection units 200 may be affected.

To eliminate performance non-uniformity of fluid injection units, an embodiment of the invention provides a fluid injection apparatus comprising fluid injection units having substantially uniform performance.

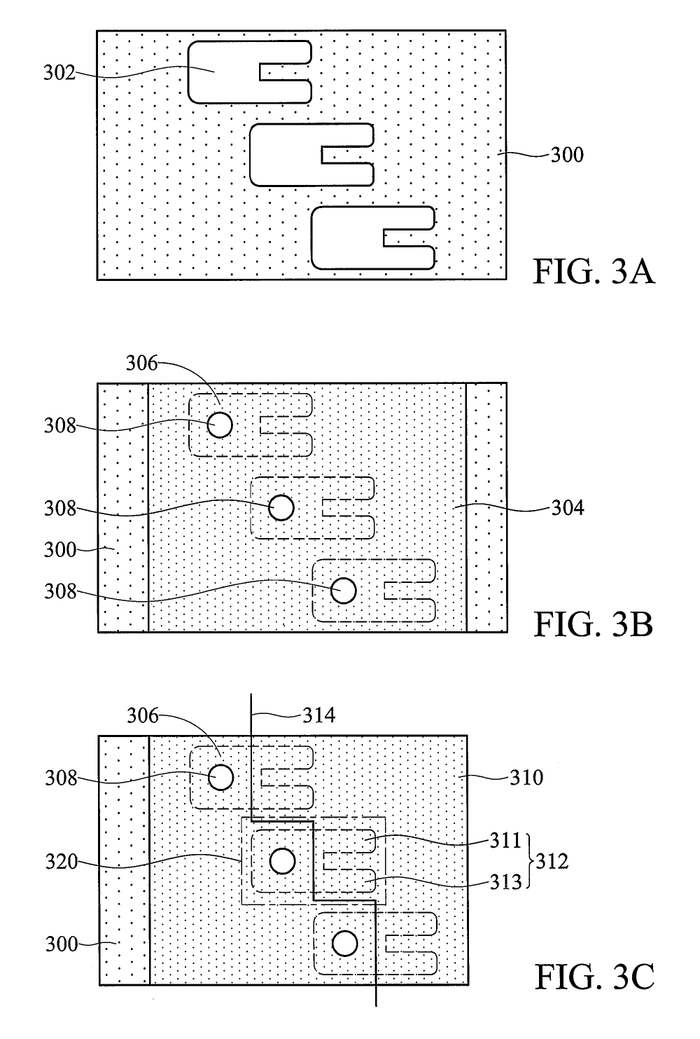

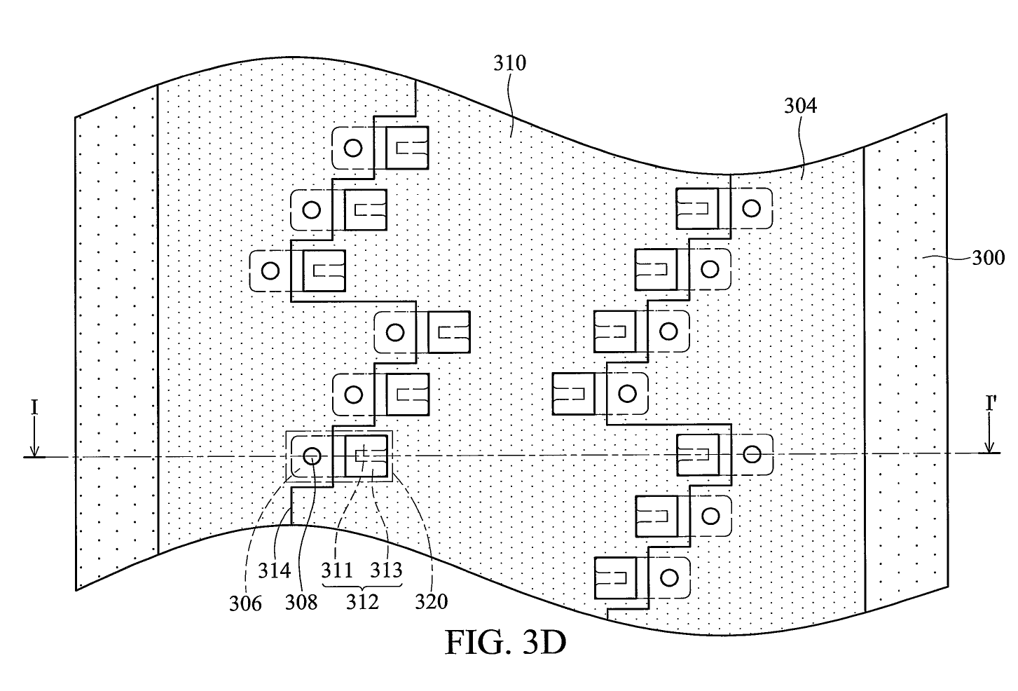

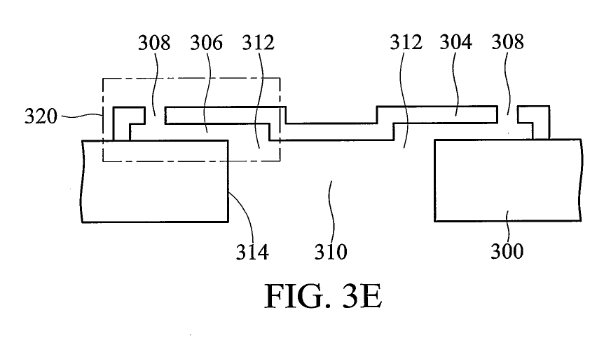

FIG. 3A˜FIG. 3C are intermediate plan views of a fluid injection apparatus of an embodiment of the invention. Referring to FIG. 3A, a substrate 300, such as silicon or glass, is provided. In a preferred embodiment of the invention, the substrate 300 is a silicon substrate. Next, a structure layer 304 is formed on the substrate 300 to define a plurality of chambers 306 on or in the substrate 300, as shown in FIG. 3B. In a preferred embodiment of the invention, the chambers 306 are not disposed along a column direction or a row direction, but along a slanting line or a zigzag line, or in a particular pattern.

Formation of the chambers 306 may comprise the following steps. As shown in FIG. 3A, a patterned sacrificial layer 302 is formed on areas predetermined for forming chambers overlying a substrate 300. Referring to FIG. 3B, a structure layer 304 is formed on the patterned sacrificial layer 302 and the substrate 300. Next, the structure layer 304 is patterned, for example by conventional lithography or etching, to form a plurality of nozzles 308 corresponding to the patterned sacrificial layer. Note that at least two nozzles 308 are not arranged in a column or in a row orientation. Arrangement of the nozzles 308 can be depended on a system of the fluid injection apparatus to optimize scanning performance. In an embodiment of the invention, the nozzles 308 are arranged along a slighting line, a curve or a zigzagged line for optimizing scanning performance of the fluid injection apparatus.

FIG. 3D is a top view of a fluid injection apparatus of an embodiment of the invention, in which FIG. 3C is a local view of FIG. 3D. FIG. 3E is a cross section along I-I′ line of FIG. 3D. Referring to FIG. 3C, FIG. 3D and FIG. 3E, backside of the substrate 300 is patterned to form a manifold 310, exposing the sacrificial layer 302. Next, the sacrificial layer is removed to form the chambers 306, each connecting the manifold 310 through a chamber inlet 312. A fluid, preferably an ink, flows from the manifold 310 to the chambers 306 through the chamber inlets 312, and further be ejected through the nozzles 308. In another embodiment of the invention, the chamber inlet 312 comprises a first inlet 311 and a second inlet 313 disposed in the manifold 310, both adjacent to the sidewall 314 of the manifold 310 and the chamber 306. The first inlet 311 and the second inlet 313 are separated by the structure layer 304 (or structure layer can also be referred as a nozzle plate).

Preferably, the sidewall 314 of the manifold 310 extends substantially along a line, parallel to another line connecting the chamber inlets 320. Thus, distances between the nozzles 308 and the manifold 310 are substantially fixed when each chamber inlet 312 and nozzle 308 is separated by the same distance. The invention, however, is not limited thereto. The principle of the embodiment is that sidewalls of the manifold 310 corresponds to the arrangement of the nozzle 308, thus the distance from the manifold 310 to the nozzles 308 is fixed. Preferably, distance between a sidewall of the manifold and each nozzle is substantially the same. More preferably, the distances between a sidewall 314 of the manifold 310 and centers of the nozzles 308 are substantially the same. The fluid injection apparatus further comprises a fluid driving device, such as a heater (not shown in the figures for simplicity), for driving fluid in the fluid injection apparatus. The invention is not limited to a particular fluid driving device or driving method. It can be designed and manufactured according to product spec or process window.

Accordingly, in a preferred embodiment of the invention, the distances between the fluid injection units 320, at least two of the fluid injection units 320 not arranged in a column or in a row, and the manifold 310 are substantially the same. Thus, the fluid injection units 320 have more uniform performance and stability and reliability of the fluid injection apparatus is increased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fluid injection apparatus, comprising:
a plurality of fluid chambers;
a manifold connecting the fluid chambers to supply fluids thereto; and
a plurality of nozzles connecting the fluid chambers respectively to eject the fluids, wherein at least two of the nozzles are not disposed along a column or a row, and distances between the nozzles and the manifold are substantially the same.

2. The fluid injection apparatus as claimed in claim 1, wherein distances between the nozzles and a sidewall of the manifold are substantially the same.

3. The fluid injection apparatus as claimed in claim 1, wherein distances between centers of the nozzles and a sidewall of the manifold are substantially the same.

4. The fluid injection apparatus as claimed in claim 1, wherein the nozzles are arranged along a slanting line.

5. The fluid injection apparatus as claimed in claim 1, wherein the nozzles are arranged along a curve, or a zigzag line.

6. A fluid injection apparatus, comprising:
a plurality of fluid chambers;
a manifold comprising a plurality of chamber inlets, connecting the fluid chambers through the chamber inlets to supply fluids to the fluid chambers respectively; and
a plurality of nozzles connecting the corresponding fluid chambers to eject the fluids, wherein at least two of the nozzles are not disposed along a column or a row, and horizontal distances between the nozzle and the manifold are substantially the same.

7. The fluid injection apparatus as claimed in claim 6, wherein horizontal distances between the nozzles and a sidewall of the manifold are substantially the same.

8. The fluid injection apparatus as claimed in claim 6, wherein horizontal distances between centers of the nozzles and a sidewall of the manifold are substantially the same.

9. The fluid injection apparatus as claimed in claim 6, wherein the nozzles are arranged along a slanting line.

10. The fluid injection apparatus as claimed in claim 6, wherein the nozzles are arranged along a curve, or a zigzag line.

11. A fluid injection apparatus, comprising:
a substrate;
a plurality of fluid chambers disposed on or in the substrate, wherein each fluid chamber comprises a nozzle plate covering the fluid chamber, each nozzle plate comprises a nozzle, and at least two of the nozzles are not disposed in a column or in a row; and
a manifold disposed in the substrate, connecting the fluid chambers, wherein horizontal distances between the nozzles and the manifold are substantially the same.

12. The fluid injection apparatus as claimed in claim 11, wherein horizontal distances between the nozzles and a sidewall of the manifold are substantially the same.

13. The fluid injection apparatus as claimed in claim 11, wherein horizontal distances between centers of the nozzles and a sidewall of the manifold are substantially the same.

14. The fluid injection apparatus as claimed in claim 11, wherein the nozzles are arranged along a slanting line.

15. The fluid injection apparatus as claimed in claim 11, wherein the nozzles are arranged along a curve, or a zigzag line.

16. The fluid injection apparatus as claimed in claim 11, wherein a sidewall of the manifold is substantially along the orientation of the curve.

17. The fluid injection apparatus as claimed in claim 11, wherein the nozzles are arranged according a system of the fluid injection apparatus.

18. The fluid injection apparatus as claimed in claim 11, wherein the manifold comprises a plurality of chamber inlets, each chamber inlet is adjacent to a sidewall of the manifold and the fluid chambers, the fluid chambers and the manifold are connected through the chamber inlets to supply fluids to the fluid chambers.

19. The fluid injection apparatus as claimed in claim 18, wherein the fluid inlets further comprise:
a first inlet adjacent to a sidewall of the manifold and the fluid chambers; and
a second inlet adjacent to a sidewall of the manifold and the fluid chambers, wherein the second inlet is adjacent to the first inlet and separated from the first inlet by a portion of the nozzle plate.

20. The fluid injection apparatus as claimed in claim 19, wherein the first inlet is separated from the nozzle by a first distance, the second inlet is separated from the nozzle by a second distance, and first distance and the second distance are substantially the same.
